(19) United States
(12) Patent Application Publication
(10) Pub. No.: US 2004/0095765 A1
(43) Pub. Date: May 20, 2004

(54) Light source unit and reflecting mirror

(76) Inventors: Shinichiro Hataoka, Osaka (JP); Makoto Horiuchi, Nara (JP); Tsuyoshi Ichibakase, Osaka (JP)

Correspondence Address: HARNESS, DICKEY & PIERCE, P.L.C., P.O. BOX 828, BLOOMFIELD HILLS, MI, 48303, US

(21) Appl. No.: 10/705,363

(22) Filed: Nov. 11, 2003

(30) Foreign Application Priority Data
Nov. 12, 2002 (JP) 2002-328049

(51) Int. Cl. F21K 7/00

(52) U.S. Cl. 362/263; 362/373

(57) ABSTRACT

A light source unit 1000 is composed of a high-pressure discharge lamp 1100 and a reflecting mirror 1200. The reflecting mirror 1200 includes a neck portion 122 to which the high-pressure discharge lamp 1100 is attached and a reflecting portion 120, which are formed as one unit. Furthermore, air holes 126 are formed in the neck portion 122. This structure enables the high-pressure discharge lamp 1100 and the reflecting mirror 1200 to be effectively cooled and ensures the start characteristics of the high-pressure discharge lamp 1100.

### BACKGROUND OF THE INVENTION

(1) Technical Field

The present invention relates to a light source unit including a high-pressure discharge lamp and a reflecting mirror used therefor.

(2) Background Art

A high-pressure discharge lamp such as a metal halide lamp and a high-pressure mercury lamp is employed as a light source for a light source unit for an image projecting apparatus (hereinafter, referred to as a light source unit) such as a liquid crystal projector and a digital micromirror device (DMD) projector. In order to make use of visible radiation radiated from this kind of high-pressure discharge lamp as effectively as possible, the light source unit is typically constructed to provide a paraboloid or ellipsoid reflecting mirror outside a luminous bulb of the high-pressure discharge lamp to surround the luminous bulb.

In recent years, this type of light source unit has become small. The downsized light source unit is significantly affected by heat from the luminous bulb of its high-pressure discharge lamp. Therefore, the luminous bulb may be devitrified to decrease the light output, or an external lead and a metal foil may be oxidized in a sealing portion of the high-pressure discharge lamp, leading to the luminous bulb leakage. In addition, when the temperature of the coldest portion of the luminous bulb becomes very high, this sometimes allows the spectral power distribution to change, leading to deteriorated color characteristics. Furthermore, when the temperature of the reflecting mirror becomes very high, a multilayer film evaporated onto the reflecting mirror may come off. In order to prevent various thermal problems from being caused by increase in the temperature of the inside of the light source unit as described above, some measures have been taken until now and have been disclosed.

A known method for preventing the thermal problems in the light source unit is one in which a high-pressure discharge lamp or a reflecting mirror is cooled by using convection. More specifically, the way of cooling is classified into cooling by a flow of the air that is aspirated from an opening located in the vicinity of the front of a concave reflecting mirror into the reflecting mirror, flows through the inside of the reflecting mirror and then is released from an opening formed in a neck portion of the reflecting mirror, as disclosed in Japanese Laid-Open Publication No. 2001-307535, and cooling by a flow of the air in the opposite direction.

However, the known light source unit disclosed in Japanese Laid-Open Publication No. 2001-307535 must comprise, in addition to a discharge lamp and a reflecting mirror, a base component for holding the discharge lamp in the neck portion to form an opening serving as an air passage in the neck portion. This is undesirable because the number of components increases so that the cost increases.

Furthermore, a large amount of cement is used to fix the discharge lamp to the reflecting mirror. The present inventors found the following problem: when the base component is attached to the neck portion, the stray capacitance in the vicinity of the neck portion increases due to this cement and the base component, and thus a start pulse is not effectively applied to the discharge lamp at the start of the discharge lamp so that it becomes hard to start the discharge lamp. The present inventors are the first finders of this problem.

### SUMMARY OF THE INVENTION

It is an object of the present invention to provide a light source unit that can cool a high-pressure discharge lamp and a reflecting mirror without including a base component and ensures good start characteristics of the high-pressure discharge lamp, and a reflecting mirror used therefor.

A light source unit of the present invention comprises: a double-ended high-pressure discharge lamp including a luminous bulb into which a luminous material is encapsulated and first and second sealing portions respectively extending from both ends of the luminous bulb; and a reflecting mirror for reflecting light emitted from the high-pressure discharge lamp, wherein the reflecting mirror comprises a reflecting portion for reflecting the light, a wide opening provided toward the direction in which the light outgoes, and a neck portion in which a narrow opening is provided to fix the high-pressure discharge lamp, said reflecting portion and said neck portion being formed as one unit, the first sealing portion of the high-pressure discharge lamp is inserted into the narrow opening of the reflecting mirror and fixed to the neck portion, and at least one air hole communicating with the narrow opening is provided in the neck portion.

In one preferred embodiment, one or more air holes are provided in the neck portion, and all of said one or more air holes are placed vertically below the lamp when viewed with the lamp turned on in a horizontal position.

In one embodiment, said at least one air hole is a slit or a circular hole.

In one embodiment, a front glass is provided over the wide opening.

A reflecting mirror of the present invention for reflecting light emitted from a high-pressure discharge lamp, comprises: a reflecting portion for reflecting the light; a wide opening provided toward the direction in which the light outgoes; and a neck portion in which a narrow opening is provided to fix the high-pressure discharge lamp, said reflecting portion and said neck portion being formed as one unit, wherein at least one air hole communicating with the narrow opening is provided in the neck portion.

According to the present invention, there can be provided a light source unit and reflecting mirror which have the following effects: since at least one air hole is provided in a neck portion of a reflecting mirror used for a light source unit, a high-pressure discharge lamp and the reflecting mirror can be cooled without providing a separate member, and since an increase in the stray capacitance caused by using a separate member does not occur, good start characteristics of the high-pressure discharge lamp are ensured.

### BRIEF DESCRIPTION OF THE DRAWINGS

FIG. 1A is a schematic view showing a light source unit according to a first embodiment viewed from a neck portion side thereof, and FIG. 1B is a cross sectional view taken along the line A-A shown in FIG. 1A.

FIG. 2A is a schematic view showing a light source unit according to a second embodiment viewed from a neck portion side thereof; FIG. 2B is a schematic diagram viewed from the B direction; and FIG. 2C is a cross sectional view taken along the line B-B shown in FIG. 2A.

FIG. 3 is a schematic cross sectional view showing a light source unit according to a third embodiment.

### DETAILED DESCRIPTION OF THE INVENTION

Embodiments of the present invention will be described hereinafter with reference to the drawings. For the sake of simplicity, the same reference numerals are given to the components having substantially the same functions. The present invention is not limited to the following embodiments.

(Embodiment 1)

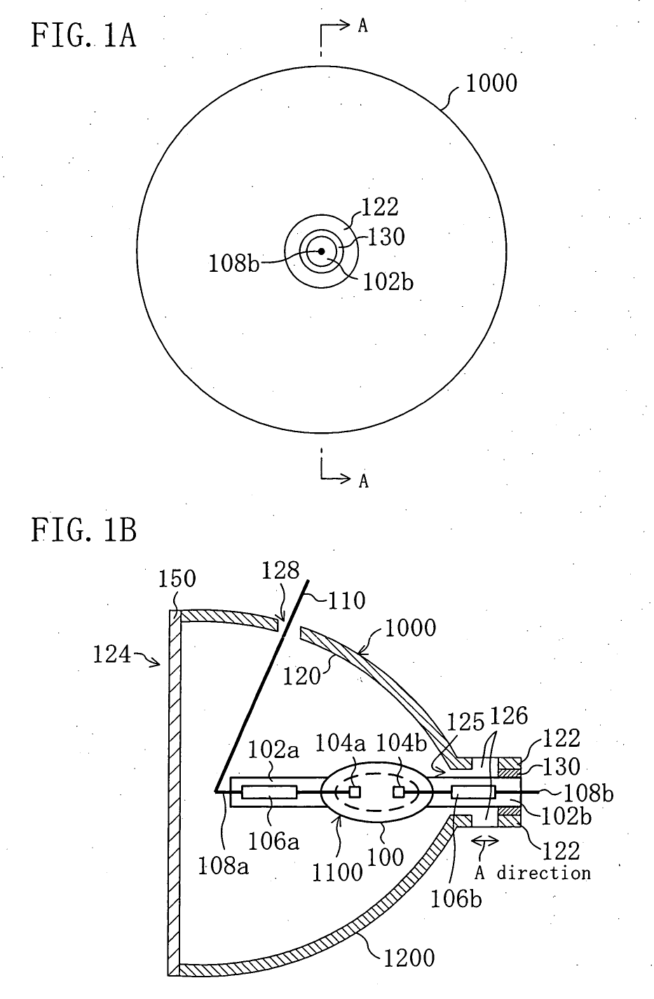

FIG. 1 is a view showing a light source unit 1000 according to a first embodiment of the present invention. FIG. 1A is a schematic view showing a light source unit 1000 viewed from a neck portion 122 side; and FIG. 1B is a cross sectional view taken along the line A-A shown in FIG. 1A.

The light source unit 1000 of this embodiment comprises a high-pressure discharge lamp 1100 and a reflecting mirror 1200 for reflecting light emitted from this high-pressure discharge lamp 1100.

The high-pressure discharge lamp 1100 is a so-called double-ended discharge lamp composed of a luminous bulb 100 made of quartz and first and second sealing portions 102a and 102b made of quartz and extending from the luminous bulb 100. The luminous bulb 100 is hollow and has an internal diameter of 5 mm and a capacity of 0.08 cc, and the whole length thereof including the lengths of the two sealing portions 102a and 102b is 55 mm. The sealing portions 102a and 102b are generally cylindrical. 16 mg mercury and argon having a pressure of 20 kPa (both not shown) are encapsulated as a luminous material in the luminous bulb 100. Therefore, this high-pressure discharge lamp 1100 is a high-pressure mercury lamp.

A pair of electrodes 104a and 104b are provided in the high-pressure discharge lamp 1100 so as to be located inside the luminous bulb 100. The distance between the tips of the electrodes is 1.0 mm. Ends of the pair of electrodes 104a and 104b opposite to the tips thereof located in the luminous bulb 100 are electrically connected to one ends of metal foils 106a and 106b made of molybdenum, respectively, and the other ends of the metal foils 106a and 106b are electrically connected to external leads 108a and 108b, respectively. Parts of the electrodes 104a and 104b, the metal foils 106a and 106b and parts of the external leads 108a and 108b are buried in the sealing portions 102a and 102b, respectively, and are sealed up using quartz. The external lead 108a extending from the second sealing portion 102a placed toward a wide opening 124 of a reflecting mirror 1200 is electrically connected to a lead 110. The lead 110 is drawn out through a through-hole 128 provided in the reflecting mirror 1200 to the outside of the reflecting mirror 1200.

The reflecting mirror 1200 comprises a reflecting portion 120 for reflecting light from the high-pressure discharge lamp 1100, a wide opening 124 provided toward the direction in which the light outgoes, and a neck portion 122 in which a narrow opening 125 is provided to fix the high-pressure discharge lamp 1100. The reflecting mirror 1200 is made of borosilicate glass having a wall thickness of 5 mm. The reflecting portion 120 and the neck portion 122 are successively formed of borosilicate glass, i.e., they are formed as one unit. The diameter of the wide opening 124 of the reflecting portion 120 is 45 mm, and the internal surface of the reflecting portion 120 is given a multi-level evaporated film made of titanium oxide (TiO₂) and silicon oxide (SiO₂). The shape of the reflecting portion 120 is appropriately selected from a paraboloid of revolution or an ellipsoid of revolution, depending on how to utilize light emitted from the opening 124 of the reflecting portion 120. The neck portion 122 is cylindrical, and a hollow portion thereof is herein also referred to as the narrow opening 125. A front glass 150 is provided on the wide opening 124. Since the front glass 150 is provided, in the case where the luminous bulb 100 is broken, broken pieces of the luminous bulb 100 can be restrained from flying out of the light source unit 1000. In particular, when the operating pressure of sealed-in materials in the luminous bulb 100 at lighting is 100 or more atmospheres, the front glass 150 is highly effective in preventing the broken pieces thereof from flying out.

In order to fix the high-pressure discharge lamp 1100 to the reflecting mirror 1200, the first sealing portion 102b is inserted into the narrow opening 125 of the neck portion 122. Here, the diameter of the first sealing portion 102b is smaller than the internal diameter of the narrow opening 125, and thus a gap is produced between the first sealing portion 102b and the internal wall of the narrow opening 125. Therefore, cement 130 is poured into this gap, thereby fixing the high-pressure discharge lamp 1100 to the reflecting mirror 1200.

Two air holes 126 and 126 passes through the neck portion 122 around the center of the neck hole in the running direction, and the cement is poured into the back end of the neck portion 122 to the extent that these air holes 126 and 126 are not filled in. These air holes 126 and 126 are slits, the lengths thereof along the A direction shown in FIG. 1B are each 5 mm, and the widths thereof orthogonal to the A direction are each 3 mm. The air holes 126 and 126 are provided in upward and downward directions as shown in FIG. 1B, respectively. The “air holes” are provided by directly working on the neck portion 122 but are not composed of the other members. That is, according to this embodiment, unlike the case that a member different from the neck portion 122 is attached to the neck portion 122 to provide holes through which the air passes in the neck portion 122 as disclosed in Japanese Laid-Open Publication No. 2001-307535, holes through which the air passes are formed in the neck portion 122 itself that is a part of the reflecting mirror.

Hereinafter, a description will be given of a thermal action at the time that the light source unit 1000 of this embodiment is operated.

When the high-pressure discharge lamp 1100 of the light source unit 1000 becomes in a steady operating state, the temperature around the luminous bulb 100, especially the temperature of the top surface of the luminous bulb 100, becomes highest, and the temperatures of the top surface of the reflecting mirror 1200 and sealing portions 102a and 102b become second highest. In this case, since the air holes 126 and 126 that are slits are provided in the neck portion 122, the cold air comes from the outside of the reflecting mirror 1200 through the air holes 126 and 126 into the reflecting mirror 1200, and the high-temperature air in the reflecting mirror 1200, especially around the luminous bulb, is released through the through-hole 128 provided in the top surface of the reflecting mirror to the outside of the reflecting mirror 1200.

It has been shown that the structure of this embodiment allows the air holes 126 provided in the neck portion 122 to be realized with a simple structure without providing a separate member and allows the above-mentioned various problems due to high temperature to be prevented by effectively cooling the inside of the reflecting mirror 1200 like air holes formed of a separate member in the known art.

Further surprisingly, it has been found that the absence of a separate member in the neck portion 122 improves the start characteristics of the light source unit 1000 of this embodiment. This will be described hereinafter.

When a separate member is attached to the neck portion 122 to provide holes through which the air passes (the separate member means one formed to cover the neck portion 122, such as a ceramic vessel through which air holes pass), there may be a case where the light source unit 1000 does not start three times every 100 times even with a pulse voltage of 18 kV being applied. On the other hand, when no separate member is provided, it normally starts and is turned on at all of one hundred start tests in which a pulse voltage of 10 through 15 kV lower than 18 kV is applied. This reason is considered as follows: the presence of the separate member allows the space between the member and the sealing portion 102b of the lamp to become a pseudo-capacitor, through which the pulse voltage leaks so that the voltage between the electrodes 104a and 104b decays. On the other hand, it is considered that in the case of this embodiment including the neck portion 122 in which a separate member is not provided, the capacitance of the pseudo-capacitor becomes small and the decay of the pulse voltage is relatively small, resulting in the light source unit certainly starting even at a low pulse voltage. That is, as compared with the case where air holes are provided using a separate member, in the case where the air holes 126 are directly formed in the neck portion 122 that is a part of the reflecting mirror 1200 without using a separate member, the high-pressure discharge lamp can be more certainly started even when the pulse voltage at start becomes lower.

As described so far, since the air holes 126 are provided in the neck portion 122 of the reflecting mirror 1200 used for the light source unit, this provides the light source unit 1000 in which the high-pressure discharge lamp 1100 and the reflecting mirror 1200 can be effectively cooled without providing a separate member and good start characteristics of the high-pressure discharge lamp 1100 can be ensured, and provides the reflecting mirror 1200 used therefor.

Although in this first embodiment the number of the air holes is two, this is merely an example and the number of air holes is not limited to this number. For example, the number of the air holes may be three, four or more as long as the strength with which the high-pressure discharge lamp 1100 is held without being detached or wobbling is kept when the first sealing portion 102b of the high-pressure discharge lamp 1100 is fixed to the neck portion 122 of the reflecting mirror 1200.

Furthermore, the length and width of each of the air holes 126 are also not restrictive to the length and width thereof in the first embodiment as long as the strength with which the high-pressure discharge lamp 1100 is held is ensured enough. Although the shape of each of the air holes 126 is a slit, it is not particularly limited, and similar effects can be obtained as long as each of the air holes 126 has a sufficient size to admit the outside air enough to cool the high-pressure discharge lamp 100. Each of the air holes 126 preferably has a circular shape appeared in the opening surface because in this case, drilling is easy.

Furthermore, in order to more effectively cool the light source unit 1000, air holes may be provided in the reflecting portion 120 of the reflecting mirror 1200. In this case, the size of each of the air holes is preferably small such that the amount of the outgoing light is not decreased. However, light source units have different optimum sizes, shapes and locations of each of air holes because of differences in cooling efficiency. The air holes are preferably provided in the upper part of the reflecting portion 120 because the cooling efficiency becomes better.

In addition, although in the first embodiment a high-pressure mercury lamp is employed, other metal lamps such as a metal halide lamp, a xenon lamp and a halogen lamp including filaments may be employed.

(Embodiment 2)

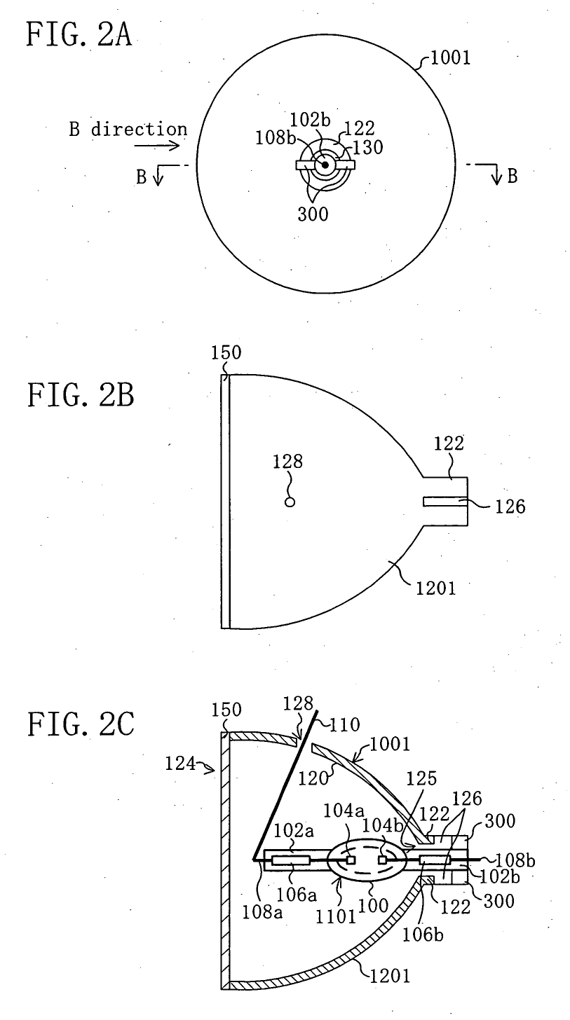

FIG. 2 shows another embodiment of a light source unit according to the present invention. FIG. 2A is a schematic view of a light source unit 1001 viewed from a neck portion 122 side. FIG. 2B is a schematic view thereof viewed from the B direction shown in FIG. 2A, and FIG. 2C is a cross sectional view taken along the line B-B shown in FIG. 2A. FIG. 2B does not show projections 300 but shows only air holes 126 to help the understanding of this drawing.

This embodiment is different from the first embodiment in that projections 300 are formed on a first sealing portion 102b and that air holes 126 extend to the back end of a neck portion 122, i.e., they are incisions extending from the back end of the neck portion 122 in the direction in which light outgoes. However, the other components are the same as those of the first embodiment. Here, the back end of the neck portion 122 represents one end of the neck portion 122 opposite to the other end thereof connected to a reflecting portion 120.

Plate-shaped projections 300 made of quartz are formed on a first sealing portion 102b of a high-pressure discharge lamp 1101 to project from a generally cylindrical body of the first sealing portion 102b. These projections 300 are formed by pressing the sealing portion 102b using a mold or the like while the sealing portion 102b is still soft in sealing. In addition, there can be provided, as another projection forming method, a method in which the projections 300 are formed by cutting the first sealing portion 102b using a carbon dioxide gas laser. Each of the projections 300 is not limited to the plate-shaped one but it may be a rod-shaped one or a convex one in which the edges of the rod-shape one are rounded. The high-pressure discharge lamp 1101 is inserted from the neck portion 122 toward a wide opening 124. The projections 300 are placed to fit into U-shaped air holes 126 that are provided in the neck portion 122 of the reflecting mirror 1201 to extend to one end of the neck portion 122 opposite to the wide opening 124. These projections 300 are placed in the location which ensures that the air holes 126 have a sufficient size to admit the outside air enough to cool the high-pressure discharge lamp 1101.

According to this embodiment, there can be provided the light source unit 1001 and the reflecting mirror 1201 which have the following effects: since the high-pressure discharge lamp 1101 is fixed to the neck portion 122 by the projections 300, the mounting strength between the high-pressure discharge lamp 1101 and the reflecting mirror 1201 can be improved; and since the air holes 126 are further provided in the neck portion 122, the high-pressure discharge lamp 1101 and the reflecting mirror 1201 can be cooled without providing a separate member, and the stray capacitance resulting from the separate member can be reduced to ensure the start characteristics of the high-pressure discharge lamp 1101. In addition, since the fixing can be carried out without using the cement 130, the number of process steps is decreased, resulting in cost reduction. Cement may be used to further increase fixing strength.

(Embodiment 3)

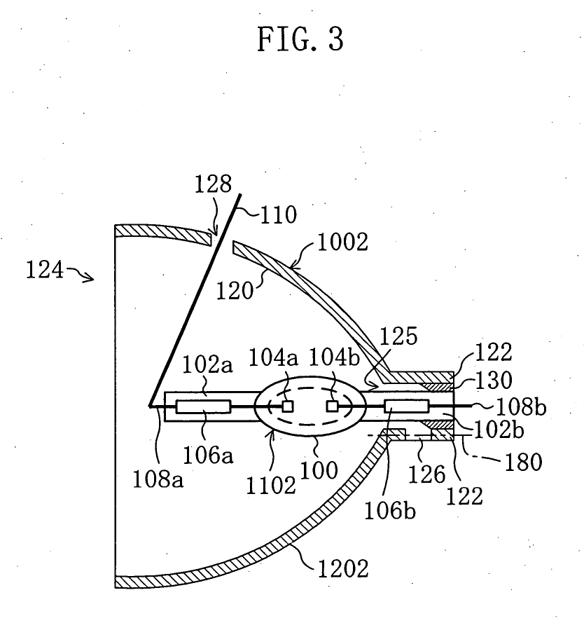

A light source unit 1002 of this embodiment shown in FIG. 3 is different from that of the first embodiment in that only one air hole 126 is provided in a neck portion 122 of a reflecting mirror 1202 and that a front glass is not provided. The air hole 126 in this embodiment is provided below a first sealing portion 102b when viewed with the first sealing portion 102 in a horizontal position. If the air hole 126 is provided in this manner, the cold air flows from the outside of the reflecting mirror 1202 through the air hole 126 into the reflecting mirror 1202, the cold air is mixed with the high-temperature air within the reflecting mirror 1202, particularly around a luminous bulb 100, and the mixed air is released from a wide opening 124 at the front of the reflecting mirror 1202 to the outside of the reflecting mirror 1202. Since the front glass is not provided, the air flows smoothly, resulting in an improved cooling efficiency. Furthermore, since a single air hole 126 is provided in the lower part of the neck portion 122 and no air hole exists in the upper part of the neck portion 122, there does not occur a situation in which the cold air flowing from the outside of a reflecting mirror 1202 through the air hole 126 into the inside thereof immediately escapes from the upper air hole so that the cold air hardly contributes to the cooling of a light source unit.

Although in this embodiment a single air hole 126 is provided in the neck portion 122, plural air holes may be provided. In this case, the air holes 126 are placed in the bottom side of the neck portion 122 when viewed with the high-pressure discharge lamp 1102 in a horizontal position turned on. In the case of putting the light source unit 1002 of this embodiment into practical use, the high-pressure discharge lamp 1102 is placed in a horizontal position, and the upper and lower sides of the reflecting mirror 1202 are fixed. Therefore, the air holes 126 can easily be placed in the bottom side of the neck portion 122. In other words, the air holes 126 are provided only in the vicinity of a single predetermined line 180 that is parallel to the direction of extension of the first sealing portion 102b and passes through the inside of the neck portion 122. The single predetermined line 180 represents a line that passes through the lowest part of the neck portion 122 and is parallel to the direction in which the first sealing portion 102b extends, and providing the air holes 126 only in the vicinity thereof means that the air holes 126 are provided only in the lower side of the neck portion 122 when viewed with the first sealing portion 102b in a horizontal position.

If the air holes 126 are provided in this manner, convection allows the outside air to easily flow through the air holes 126 into the inside of a light source unit 1000. Thus, cooling can effectively be carried out. Also in the case of this embodiment (a single air hole 126 is provided), it can be said that the air hole 126 is provided only in the vicinity of the predetermined line 180 that is parallel to the direction of extension of the first sealing portion 102b and passes through the inside of the neck portion 122.

Cement 130 is used to fix the high-pressure discharge lamp 1102 to the reflecting mirror 1202. In this case, there is a possibility that a small amount of cement 130 may flow before the cement 130 sets so that the air hole 126 is partly blocked. However, in this embodiment, when the cement 130 is used for fixing, the cement 130 is set with the air hole 126 being directed upward, i.e., with the position shown in FIG. 3 being turned upside down, whereby the cement 130 does not flow into the air hole 126 and the air hole 126 is not blocked.

Even when a front glass is provided over the opening 124, a cooling effect can be obtained because the air flows out through an through-hole 128 or air holes provided in the reflecting surface of the reflecting mirror 1202.

In any one of the above-described first through third embodiments, it is needless to say that when a fan for forcibly ventilating the light source unit to the outside thereof is further provided, an improved cooling effect is obtained.

The entire content of JP 2002-328049 is incorporated herein by reference.

What is claimed is:

1. A light source unit comprising:
a double-ended high-pressure discharge lamp including a luminous bulb into which a luminous material is encapsulated and first and second sealing portions respectively extending from both ends of the luminous bulb; and
a reflecting mirror for reflecting light emitted from the high-pressure discharge lamp,
wherein the reflecting mirror comprises a reflecting portion for reflecting the light, a wide opening provided toward the direction in which the light outgoes, and a neck portion in which a narrow opening is provided to fix the high-pressure discharge lamp, said reflecting portion and said neck portion being formed as one unit,
the first sealing portion of the high-pressure discharge lamp is inserted into the narrow opening of the reflecting mirror and fixed to the neck portion, and
at least one air hole communicating with the narrow opening is provided in the neck portion.

2. The light source unit of claim 1, wherein
one or more air holes are provided in the neck portion, and all of said one or more air holes are placed vertically below the lamp when viewed with the lamp turned on in a horizontal position.

3. The light source unit of claim 1, wherein
said at least one air hole is a slit or a circular hole.

4. The light source unit of claim 1, wherein
a front glass is provided over the wide opening.

5. A reflecting mirror for reflecting light emitted from a high-pressure discharge lamp, comprising:
a reflecting portion for reflecting the light;
a wide opening provided toward the direction in which the light outgoes; and
a neck portion in which a narrow opening is provided to fix the high-pressure discharge lamp, said reflecting portion and said neck portion being formed as one unit,
wherein at least one air hole communicating with the narrow opening is provided in the neck portion.
